(19) United States
(12) Patent Application Publication
(10) Pub. No.: US 2009/0058842 A1
(43) Pub. Date: Mar. 5, 2009

(54) Devices and methods for controlling a display to conserve power

(75) Inventors: William Bull, Campbell, CA (US); Policarpo Wood, Cupertino, CA (US); Guy Bar-Nahum, San Francisco, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/154,887

(22) Filed: May 27, 2008

Related U.S. Application Data
(60) Provisional application No. 60/967,499, filed on Sep. 4, 2007.

(51) Int. Cl. G09G 5/00; G06T 13/00

(52) U.S. Cl. 345/212; 345/473

(57) ABSTRACT

Devices and methods for controlling display output based application class and/or on one or more monitored device parameters are described herein. These devices and methods can be advantageous because they can reduce power consumption, and can improve user experience. For example, devices and methods comprising determining an application class, wherein for the first class of applications no display simplifications are used, and wherein for the second class of applications a device parameter is monitored such that if a first state is detected, full graphics are displayed, and if the second state is detected, simplified graphics are displayed are described. In some embodiments, the applications can include video applications, audio applications, and radio applications, for example. In some embodiments, the device parameter can comprise user input frequency, power supply charge, and backlight intensity, for example.

### CROSS-REFERENCE TO RELATED APPLICATIONS

This application claims the benefit of U.S. Provisional Patent Application No. 60/967,499, filed Sep. 4, 2007, which is hereby incorporated by reference herein in its entirety.

### BACKGROUND OF THE INVENTION

Consumption of power can be an important consideration in the design of electronic devices, especially portable electronic devices (e.g., laptop computers, cellular telephones, and handheld media players). Many electronic devices are powered by batteries, which generally provide a finite amount of electrical power to the device. Because of the limited amount of power available to the electronic device, maximizing efficiency and/or battery life can be important.

Many factors can affect the power consumption of an electronic device. Power consumption can be affected by, for example, the frequency and nature of the usage of the device, the application(s) being run by the device, the amount and nature of information within media (e.g., images, video, etc.) presented by the device, the rate of change of the information displayed by the device, and the activity of display-related devices, such as backlights.

Electronic devices are generally able to run applications, and these applications can cause a display to consumer power at varying rates. For example, information presented to the user in video applications may continuously change, and therefore require continuous refreshing of the display. On the other hand, applications that play audio files may not need to change the information on the display as regularly or as extensively as applications that play video files, because the user may be not be viewing the display as attentively when the file is playing, for example.

Some electronic devices are configured to enter power saving modes, wherein the devices enter a state that consumes less power than when fully active. One example of such a power saving mode is where a processor, upon detecting a period of user inactivity, dims a display (e.g., a display on an electronic device), or activates a conventional screen saver. Another example can be a “sleep mode” or “hibernation” of an electronic device, wherein components of a system are powered down when a period of user inactivity is detected. However, a disadvantage of using current power saving systems and methods is that these systems and methods generally require shutting-down components (e.g., placing a display component into a stand-by mode) or functional aspects of components (e.g., screensavers or dimming of the display). Presently, device must exit the power saving mode and become active before providing information to the user.

### SUMMARY OF THE INVENTION

Among other things, apparatuses and methods for controlling a display based on application class or one or more monitored device parameters are described herein. These apparatuses and methods are advantageous at least because they reduce power consumption, and improve the user experience.

For example, devices and methods can be provided that can group applications executed by the electronic device into classes. In some embodiments, the applications include, for example, video applications, audio applications, and calendar applications. A first application class can include applications where full graphics are displayed. A second application class can depend on a device parameter such that full graphics are displayed when the parameter is in a first state, and simplified graphics are displayed when the parameter is in a second state is detected.

A device parameter can include, for example, user input frequency, power supply charge, and backlight intensity. Simplified graphics can include, for example, a reduced-color display, a display including fewer status indicators, a display having status indicators displayed at a lower resolution, and displaying simplified animations. In some embodiments, the monitored device parameter can be the application class, wherein all applications in the second application class display simplified graphics.

In some embodiments, an application belonging to the second application class can be a preview pane, wherein animation relating to a highlighted file can be displayed. A device parameter can be monitored to determine if full animation is displayed or simplified animation is displayed. If the device parameter is in a first state, full animation can be displayed for the highlighted file. If, on the other hand, the device parameter is in a second state, simplified animation can be displayed for the highlighted file.

### BRIEF DESCRIPTION OF THE DRAWINGS

The above and other advantages of the present invention will become more apparent upon consideration of the following detailed description, taken in conjunction with the accompanying drawings, in which like reference characters refer to like parts throughout, and in which:

FIG. 1 is a simplified block diagram of an illustrative electronic device that operates in accordance with an embodiment of the present invention;

FIG. 2 is a flow chart illustrating an exemplary process for controlling a display based on application class and one or more monitored device parameters in accordance with an embodiment of the present invention;

FIG. 3 is a flow chart illustrating an exemplary process for controlling a display based on one or more monitored device parameters in accordance with an embodiment of the present invention;

FIGS. 4A-4B show illustrative user interfaces on a display in which a display can be controlled based on one or more monitored device parameters in accordance with an embodiment of the present invention;

FIG. 5 is a flow chart illustrating an exemplary process for controlling a display based on one or more monitored device parameters in accordance with another embodiment of the present invention;

FIGS. 6A-6B show illustrative user interfaces on a display in which a display can be controlled based on one or more monitored device parameters in accordance with another embodiment of the present invention; and

FIGS. 7A-7P show illustrative reduced-color screens in accordance with embodiments of the present invention.

### DETAILED DESCRIPTION OF THE INVENTION

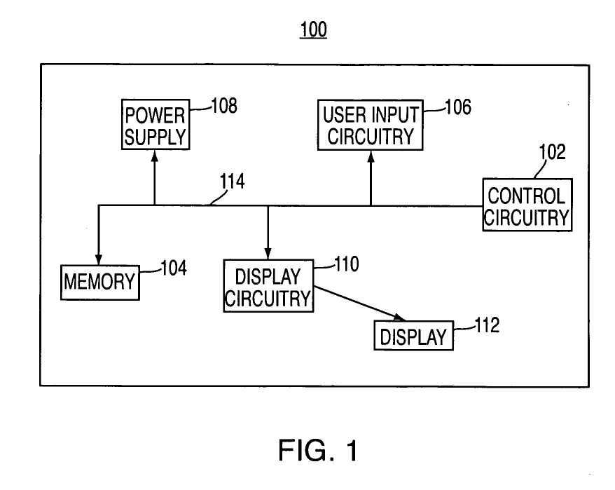

Apparatuses and methods for providing electronic devices that control a display based on application class and/or monitored device parameters are provided and described with reference to FIGS. 1-7. The present invention can be used to improve power consumption and the user experience of electronic devices by alternating the display between displaying full graphics and displaying simplified graphics. The changing of the display can be based upon application class and/or monitored device parameters. The present invention is advantageous at least because power consumption can be reduced based on device status and/or user needs. This can result in the electronic device being more efficient with regard to its power consumption and can improve battery life.

An electronic device of the present invention may be any electronic device operative to control a display based upon application class and/or monitored device parameters. In some embodiments, an electronic device of the present invention may be any electronic device operative to, upon detection of a predetermined condition, change display mode to display a reduced-color screen. An electronic device of the present invention can also be any electronic device operative to display full animation until it detects a predetermined condition, at which point the electronic device can display simplified animation.

The term “electronic device” can include, but is not limited to, music players, video players, still image players, game players, other media players, music recorders, video recorders, cameras, other media recorders, radios, medical equipment, calculators, cellular telephones, other wireless communication devices, personal digital assistants, programmable remote controls, pagers, laptop computers, printers, or combinations thereof. In some cases, the electronic devices may perform a single function and, in other cases, the electronic devices may perform multiple functions (e.g., a device that plays music, displays video, stores pictures, and receives and transmits telephone calls, such as an iphone™ marketed by Apple Inc., of Cupertino, Calif.).

Electronic devices of the present invention can be, for example, any portable, mobile, hand-held, or miniature electronic device. Miniature electronic devices may have a form factor that is smaller than that of hand-held electronic devices. Illustrative miniature electronic devices can be integrated into various objects that include, but are not limited to, watches, rings, necklaces, belts, accessories for belts, headsets, accessories for shoes, virtual reality devices, other wearable electronics, accessories for sporting equipment, accessories for fitness equipment, key chains, or combinations thereof. Alternatively, electronic devices that incorporate an input component of the invention may not be portable at all.

An electronic device can have a plurality of applications available for user selection, which each can perform functions for the user. These applications can include, for example, applications for playing video files (“video applications”), applications for playing audio files (“audio applications”), applications for tuning the frequency of a radio receiver (“radio applications”), interactive or game applications, communication applications, organization applications (e.g., calendar applications), timer applications, security applications (e.g., device-locking applications), preview panes, and/or searching applications. Communication applications can include applications that can be used to communicate with one or more other electronic devices, such as, for example, instant messaging applications or file transfer applications.

Applications can be classified, or organized into groups, according to their use of the electronic device's display and power consumption. A first application class, for example, can include applications that cause substantially continuous refreshing of information on the display and thereby can have higher power consumption. Examples of applications that could belong to such a first application class include video applications, game applications, and timer applications.

A second application class can include, for example, applications that can operate while refreshing the displayed information at a slower rate than applications in the first application class, and thereby can have lower power consumption as well. Examples of applications that could belong to the second application class include audio applications, searching applications, and preview panes.

A device parameter can include a device factor or characteristic which can be varied or has a range of variations. For example, a device parameter can include user input frequency (e.g., the frequency with which a user presses any button or interacts with the electronic device's user input component, etc.), remaining power (e.g., whether the battery's charge is greater or less than a predetermined amount, such as 75%, 50%, 25%, 10%, or any desired percentage of the power supply's full charge), whether or not the power supply is being charged by an external power source, status of another component of the electronic device (such as the backlight being at full intensity, half intensity, or any desired fraction of full intensity), status of an application (e.g., whether playback of a music or video file is ongoing, paused, or stopped) and the number of slides in a slideshow. A device parameter, in some embodiments, can also be whether or not an application from the second application class has been selected by the user. Simplified graphics can be displayed in these embodiments effectively upon the selection of an application belonging to the second application class.

“Full graphics” can refer to a default set of information displayed for an application on the electronic device. Information can include, for example, color quality, the resolution of displayed graphics, the length and/or complexity of animations or videos, status indicators, text information, still image information, and the intensity of the backlight. Color quality can refer to the number of colors displayed on the display. Resolution of displayed graphics can refer to the number of pixels used to represent graphics. Resolution can also refer to the amount or level of detail used for graphics. Animation can refer to video playback, the cycling of a slideshow of still images, or the use of graphic effects as described herein. Status indicators can refer to either or both device status indicators and application status indicators. Device status indicators can indicate the status of device components, such as, e.g., the power source or-the device input-lock. Application status indicators can indicate the status of an application running on the electronic device, such as whether or not a file is being played back, or what the volume is for a file being played back, or the frequency to which a radio application is tuned.

For example, in an audio application, the full graphics can include status indicators (e.g., remaining charge in the power source, whether the audio file is playing or is paused etc.), text information (such as, e.g., the artist and title of the audio file), and/or still image information such as an album cover.

“Simplified graphics” can mean graphics with at least one simplification, or reduction in the set of information displayed under full graphics. Examples of graphics simplifications can include reduction or elimination of backlighting, lowering of resolution, shortening or elimination of animation, reduction or elimination of graphical effects, reduction of the number of status indicators provided on the display, and reduction of colors used on the display. For an audio application, for example, simplified graphics can include displaying only the status indicator for whether or not the current audio file is being played or paused, the charge remaining in the power supply, and/or the time of day stored in the device.

FIG. 1 illustrates a simplified block diagram of an illustrative electronic device that operates in accordance with an embodiment of the present invention. Electronic device 100 can include control circuitry 102, local client memory 104, user input circuitry 106, power supply 108, display circuitry 110, bus 114, and display 112. In some embodiments, electronic device 100 can include more than one of each component, but for the sake of illustration, only one is shown in FIG. 1. Also, while FIG. 1 illustrates components 102-112 integrated with device 100, one or more components can be disposed external to the device and coupled thereto (e.g., display 112).

Memory 104 can include one or more storage mediums, including for example, a hard-drive, flash memory, permanent memory such as ROM, semi-permanent memory such as RAM, any other suitable type of storage component, or any combination thereof. Memory 104 can include cache memory, which may be one or more different types of memory used for temporarily storing data for electronic device applications. Memory 104 may store media data (e.g., music and video files), software (e.g., for implementing functions on device 100), firmware, preference information (e.g., media playback preferences), contacts information (e.g., telephone numbers and email addresses), calendar information, any other suitable data, or any combination thereof.

Display circuitry 110 can accept and/or generate signals for presenting media information (e.g., textual, graphical, tactile, and audible information) on display 112. For example, display circuitry 110 can include a coder/decoder (CODEC) to convert digital media signals into analog signals. Display circuitry 110 also can include display driver circuitry and/or circuitry for driving display driver(s). Display control signals, which can control what information is displayed by display 112, can be generated by control circuitry 102 or display circuitry 110. In some embodiments, display circuitry 110 and control circuitry 102 can be the same, or display circuitry 110 can be subsumed within control circuitry 102.

In one embodiment, display 112 can be integrated with or externally coupled to electronic device 100. Display 112 may take any of various forms, including, but not limited to, audio speakers, headphones, audio line-outs, visual displays, proximity-sensitive displays, or combinations thereof.

Display 112 can also have its own local or cache memory in some embodiments. Display control signals can be sent from control circuitry 102 or display circuitry 110 to the local memory of display 112, which can subsequently cause the corresponding information to be displayed.

Electronic device 100 also may be equipped with user input circuitry 106 that can permit a user to interact or interface with device 100. For example, user input circuitry 106 can take a variety of forms, including, but not limited to, buttons, electronic device pads, dials, trackballs, joysticks, switches, microphones, click wheels, touch screens, electronics for accepting audio and/or visual information, antennas, infrared ports, or combinations thereof. User input circuitry 106 may include a multi-touch screen such as that described in U.S. Pat. No. 6,323,846, which is incorporated by reference herein in its entirety. User input circuitry 106 may emulate a rotary phone or a multi-button electronic device pad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety.

Bus 114 can provide a data transfer path for transferring data to, from, or between control circuitry 102, local client memory 104, user input circuitry 106, power supply 108, display circuitry 110, and any other components of device 100.

Power supply 108 can provide power to the components of device 100. In some embodiments, power supply 108 can be coupled to a power grid (e.g., a personal computer). In some embodiments, power supply 108 can include one or more batteries for providing power in a portable device (e.g., a portable music player). As another example, power supply 108 can be configured to generate power in a portable device from a natural source (e.g., solar power using solar cells). As set forth herein, electronic device 100 can be operated in accordance with the principles of the present invention in order to control a display based upon application class and/or monitored device parameters.

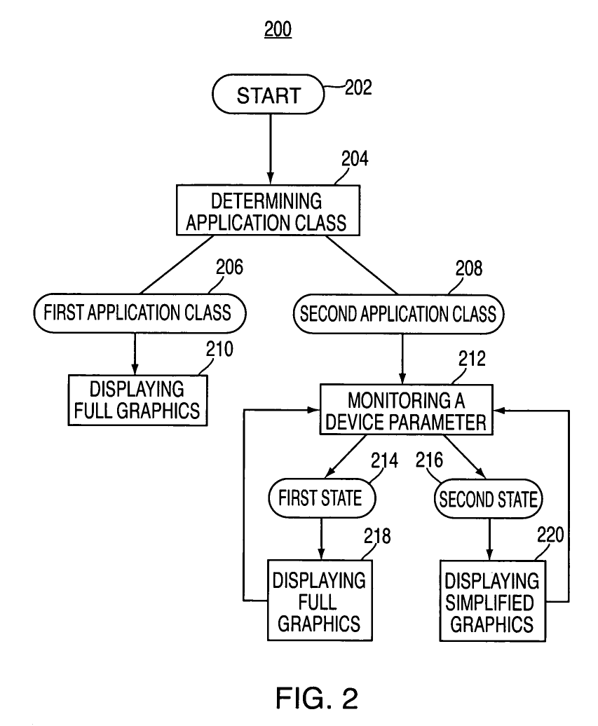

FIG. 2 is a flow chart illustrating an exemplary process for controlling display output based on application class and one or more monitored device parameters in accordance with an embodiment of the present invention.

At step 202, the electronic device can be initialized. At step 204, the application class can be determined. While two classes are illustratively described in this embodiment, the present invention is not limited to any particular number of classes. In certain embodiments, there can be one class, or alternatively as many classes as is desired. Applications can be grouped by the way in which the display is used and/or on the basis of power consumption. In some embodiments, all applications belong to the second application class, and no applications belong to the first application class.

If the user application belongs to the first application class, then step 206 can be executed and the electronic device can display full graphics at step 210. No simplifications are made because, for example, the graphics can be more important for applications belonging to the first application class than in other applications. In such a case, a simplification of display features could interfere with the user experience. For example, if the application includes playback of a video file or a game application, a user generally would prefer full graphics to be displayed, because the primary focus of the user is on the display, and it can be desirable to display a rich amount of information. In some embodiments, however, the electronic device can override the display of full graphics for applications belonging to the first application class. This can be done, for example, by receiving a user command to provide simplified graphics.

If the application belongs to the second application class, then step 208 can be executed and the electronic device can monitor one or more device parameters at step 212. Device parameters may be monitored substantially in parallel, or can be monitored serially (e.g., a first parameter can be monitored, and after a state is detected, a second parameter can be monitored).

At step 212, the electronic device can monitor one or more device parameters. This can mean that the device determines what state the device is currently in with respect to the monitored parameters. For example, user input frequency can be a monitored device parameter. At step 212, the device could determine if the user input frequency compares in a predetermined manner to a predetermined value. For example, a high user input frequency, wherein a time less than or equal to than a predetermined period of time passes between user inputs, can correspond to first state 214. Similarly, a low user input frequency, wherein more than the predetermined period of time passes between user inputs, could correspond to second state 216. At step 212, the electronic device could monitor the user input frequency to see if it was presently in the first state or the second state. First state 214 and second state 216 can be executed substantially at the time when the user input frequency is detected, or can be executed a predetermined amount of time after the appropriate user input frequency is detected. The predetermined manner of comparison can be based on a substantially instantaneous reading of the user input frequency, or can be based on a mean or average taken over a predetermined period of time.

While the process 200 shows two states, the present invention is not limited in this respect, and as many states can be implemented as desirable. For example, the states can each correspond to a different status of the device parameter being monitored (e.g., different frequencies of user input).

If the device parameter status corresponding to first state 214 is detected by the electronic device at step 212, then step 218 can be executed and full graphics can be displayed. Process 200 can be advantageous at least because it can display full graphics when doing so can enhance utility, based upon monitored device parameters. Fore example, take the example described above, wherein the parameter being monitored is frequency of user input, and first state 214 corresponds to a high frequency of user input. Because a user is generally focusing on the display when the user input frequency is high, simplifications in the graphics or graphic presentation of the display can adversely affect or detract from the user's experience.

In some embodiments, first state 214 can be the default state of the electronic device after a application belonging to the second application class is detected at step 204. After the full graphics are displayed at step 218, the electronic device can resume monitoring the device parameter or parameters at step 212.

If the device parameter status corresponding to second state 216 is detected by the electronic device at step 212, then step 220 can be executed and simplified graphics can be displayed. Simplified graphics can take the form of any of those described hereinabove. After simplification of the graphics has been performed, the electronic device can resume monitoring the device parameter or parameters at step 212.

The simplification of graphics can be done all at once, or can take place progressively. For example, if a device parameter or application class indicates that simplified graphics can be used, the full graphics can be simplified on the display by reducing the intensity of a backlight by a given percentage. After a predetermined period of time passes, the intensity of the backlight can then be further reduced, or the backlight can be turned off, thereby progressively displaying simplified graphics.

Simplifying the graphics of an electronic device can be advantageous because, for example, it can reduce the power consumption of the electronic device. This reduction can come in two primary forms. First, because less information is displayed, demands upon the control circuitry, bus, memory, and/or display circuitry can be reduced, which can reduce power consumption. Second, the display itself can consume less power because the display, or related hardware such as the backlight, are generally less active when the graphic simplifications are implemented.

Reducing power consumption can be beneficial because it can generally enhance efficiency and the user experience. For example, these enhancements may come in the form of longer periods of time between recharging or replacing the power supply of the electronic device, greater convenience and portability, and increasing the useful life of the power source (e.g., because discharge and recharge of the power source can cause wear to the power source and reduce its useful life) and/or of the electronic device, for example.

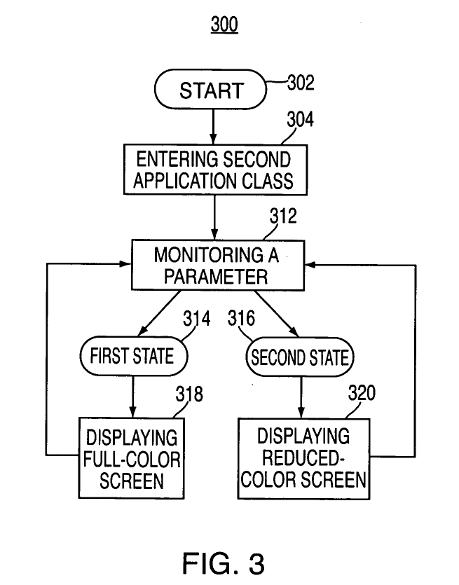

FIG. 3 is a flow chart illustrating an exemplary process for controlling a display based on one or more monitored device parameters in accordance with an embodiment of the present invention. At step 302, the application can be initialized, and at step 304, a application belonging to the second application class can be entered as described above with respect to FIG. 2.

As described hereinabove, one or more device parameters are monitored at step 312. For example, in the embodiment described in process 300, the application can be an audio application, and a device parameter can be user input frequency. There can be two states for the device parameter monitored at step 312: first state 314, which can be a high frequency state wherein less than a predetermined period of time passes between user inputs, and second state 316, which can be a low frequency state wherein more than the predetermined period of time passes between user inputs. Examples of actions that can indicate a high frequency state 314 can include instances where a user is skipping or changing the play position within an audio file, browsing through audio files, and navigating menus.

The predetermined period of time used to differentiate between high frequency state 314 and low frequency state 316 can be a fixed period of time or can be a variable period of time, affected by a device parameter such as battery life. The predetermined period of time can be set by a user of the electronic device, or can be set automatically by the device. In some embodiments, a device parameter monitored in process 300 can be the status of a device locking switch, which can disable all other user input circuitry, for example. In these embodiments, first state 314 can correspond to the device locking switch being placed in its “off” position. Likewise, second state 316 can correspond to the device locking switch being placed in its “on” position. In certain embodiments, both the device locking switch and the user input frequency can be monitored at step 312.

In certain embodiments, a device parameter monitored in process 300 can be the status of an application. Using an audio application as an example, first state 314 can correspond to when the audio file being played back is playing. Second state 316 can then correspond to when the audio file is paused or stopped, for example.

If the parameter status corresponding to first state 314 are detected by the electronic device at step 312, then step 318 can be executed and a full graphics, full-color screen, meaning graphics with no simplifications (e.g., reduction in backlighting, reduction of colors used, etc.) can be displayed. All information can be presented in full-color, meaning presented while having access to the display's entire color palette.

Process 300 can be advantageous because a user is generally focusing on the information presented on the electronic device's display when the user input frequency is high, and simplifications in the graphics or graphic presentation of the display can adversely affect or detract from the user's experience. For example, when user input frequency is high during an audio application, the user generally is observing and interacting with the electronic device, and simplifications in the graphics or graphic presentation could detract from the user's experience by, for example, making the display harder to see or hiding information pertinent to the user's activity. After step 318, the electronic device can resume monitoring the device parameter or parameters at step 312. In some embodiments, the electronic device can default to the full graphics, full-color screen when the application belonging to the second application class is entered at step 304.

If the parameter status corresponding to second state 316 is detected by the electronic device at step 312, then the display mode of the electronic device can be changed. The electronic device can have multiple display modes, including a display mode that can have access to and use the display's entire color palette to present information (“full-color” mode), and a display mode that uses a reduced number of bits compared to full-color mode to present information (“reduced-color” mode).

One example of a reduced-color mode is a mode in which graphics are provided in grayscale, or black and white, or a less rich color palette (i.e., having a reduced number of bits compared to full-color). This can be implemented by using three data bits per sampled pixel to present information to a user, for example. Embodiments using black and white or grayscale mode can have an additional advantage in that the images provided generally can be more easily viewed on a display lacking a backlight, or on a display wherein backlighting has been dimmed or turned off.

At step 320, a screen providing device information using a reduced-color mode can be displayed. The screen provided at step 320 can display the same information presented on the full-graphics, full-color screen, or can display a partial display, wherein only a reduced number of status indicators can be provided. This reduced number of status indicators can include information relating to the status of the electronic device, such as the time or charge remaining on the power source, and/or application info such as if the device is playing an audio file or the radio frequency to which the device is tuned. In some embodiments, the screen providing device information using a reduced-color mode can be accompanied with dimming or turning off of the backlight of the electronic device.

Step 320 can be implemented in any known way. In some embodiments, when the reduced-color screen providing device information is displayed, the refresh rate of the display can be reduced. For example, the display can refresh information multiple times per second while displaying full-graphics, full-color screens. The reduced-color screen providing device information, however, may refresh information after a longer period of time (e.g., one minute, 30 seconds, two minutes, or any time interval desired), or when a change in the device information displayed takes place (e.g., the minute digits of the time of day stored by the electronic device advance), such that the reduced-color screen providing device information refreshes more slowly than the full-graphics, full-color screen. After step 320, the electronic device can resume monitoring the device parameter or parameters at step 312.

The embodiment displayed in process 300 can further reduce power consumption of the electronic device, which can result in improved efficiency and an enhanced user experience, because reduced-color screen providing device information generally consumes less power than a full graphics, full-color display for the reasons discussed herein (e.g., fewer requests upon the bus, reduced demands upon the display, slower refresh rate). Reductions in power consumption can result, for example, from less information being loaded onto the display's local memory, reduced refreshing of the display's local memory, and the use of fewer display pixels. In some embodiments, multiple hours of power source life can be saved.

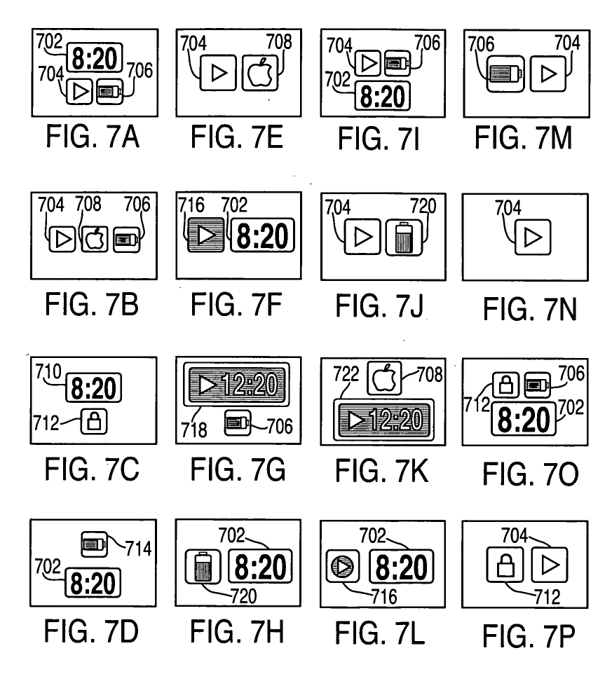

Additionally, greater reductions in power consumption can be obtained if the reduced-color screen providing device information described above is implemented using a lower resolution mode, or is accompanied with a reduction of backlight intensity, or any combination of the two. Additionally, process 300 can be advantageous to a known screen saver and the like because it can display device information and can be responsive to device parameters. Please refer to FIG. 7 and the accompanying text for examples of reduced-color screens providing device information.

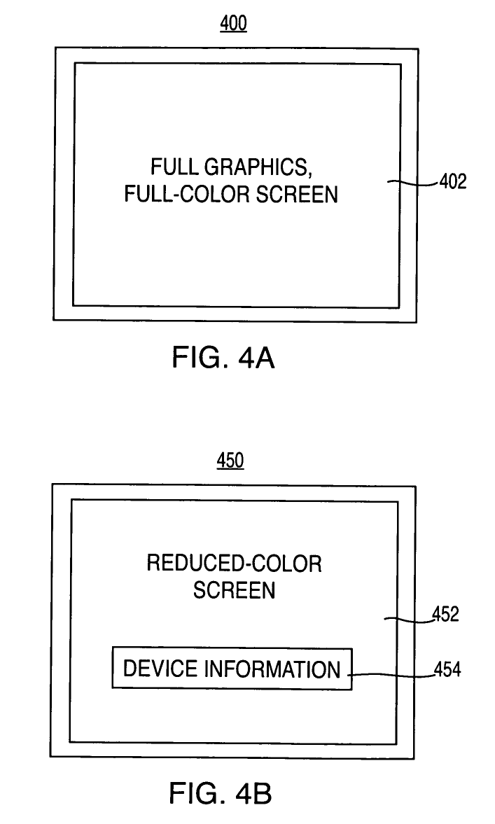

FIGS. 4A-4B show illustrative user interfaces on a display in which a display can be controlled based on one or more monitored device parameters in accordance with an embodiment of the present invention. FIGS. 4A and 4B can illustrate embodiments discussed in process 300.

User interface 400 can illustrate full-graphics, full-color screen 402, as described hereinabove in relation to step 318 of process 300. Full graphics, full-color screen 402 can in some embodiments contain a full set of status indicators, which can correspond to device or application parameters.

User interface 450 can illustrate reduced-color screen 452, which can include device information 454 as described hereinabove in relation to step 320 of process 300. As stated above, the embodiments displayed in user interfaces 400 and 450 can further reduce power consumption of the electronic device, which can result in improved efficiency and an enhanced user experience, because a reduced-color screen that generally consumes less power than a full graphics, full-color display for the reasons discussed herein is provided. Additionally, greater reductions in power consumption can be obtained if the reduced-color screen is implemented using a lower resolution mode, or is accompanied with a reduction of backlight intensity, or any combination of the two.

In some embodiments, the simplified graphics can be full-color displays that display a simplified set of status indicators compared to full graphics, full-color display 402. The simplification can, for example, be in the form of a reduced number of status indicators, or can present similar status indicators as full graphics, full-color display 402 that have a lower resolution (e.g., an indicator of power remaining that only shows power remaining in increments of 10%, 25%, or any desired percentage of the power supply's full charge). These embodiments can also enhance user experience because a reduced-color screen that generally consumes less power than a full graphics, full-color display for the reasons discussed herein is provided.

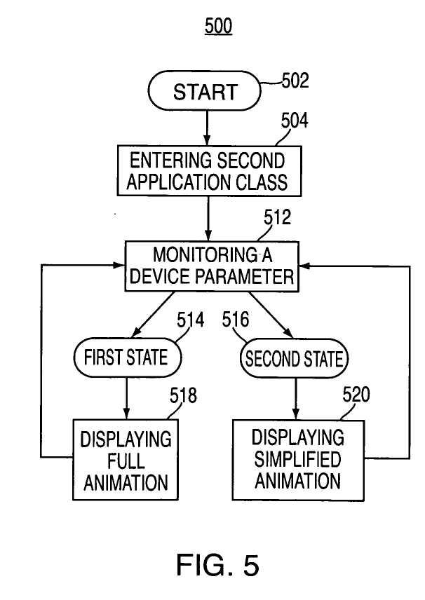

FIG. 5 is a flow chart illustrating an exemplary process for controlling a display based on one or more monitored device parameters in accordance with another embodiment of the present invention. At step 502, the application can be initialized, and at step 504, an application belonging to the second application class can be entered as described hereinabove.

For example, in some embodiments the application belonging to the second application class can be a “preview pane” for browsing files on the electronic device, which can include dividing the screen into two or more display areas, the division of which can take place vertically, for example. In some embodiments, the left display area can show file names, which a user can highlight and cause to scroll. The right display area can show animation associated with the highlighted file. The animation can be video information, or slides containing still images (e.g., selections of album artwork).

For example, if a user is browsing through music files on the left display area, the right display area can show a slideshow of album art. In some embodiments, the slideshow can be accompanied with various animation effects, such as dissolves, wipes, cuts, and any other known transition effect. Another example of the preview pane can relate to video files. While the user browses through video files in the left display area, the right display area can show excerpts of the video file, for example.

At step 512, the electronic device monitors one or more device parameters, as described hereinabove. For example, where a preview pane as described above is entered, the electronic device can monitor user input frequency, whereby there can be a high frequency state 514, wherein less than a predetermined period of time passes between user inputs, and low frequency state 516, wherein more than the predetermined period of time passes between user inputs. The predetermined period of time can be fixed or variable, as described hereinabove.

The electronic device also can monitor the number of album art images associated with a highlighted audio file. For example, the first state can relate to cases where there are multiple album art images, and the second state can relate to cases where there is one album art image associated with the highlighted audio file. In another embodiment, the electronic device can monitor the status of an application. For example, the first state can include the state where an application is playing back an audio file, and the second state can include the state where playback is paused or stopped.

If the first state is detected at step 512, then step 514 can be executed, and at step 518, the full animation related to the file highlighted in the left display area can be displayed on the right display area, for example. The full animation can include a loop of an excerpt of a video file (the excerpt of which can be a separate file, or can be a preselected section of the video file), or a looping slideshow of album art associated with a highlighted audio file, which can be enhanced with the above mentioned animation techniques, for example.

After step 518, the electronic device can resume monitoring-the device parameter-or parameters at step 512.

If the second state is detected at step 512, then step 516 can be executed, and at step 520, simplified animation related to the file highlighted in the left display area can be displayed on the right display area, for example. The simplified animation can include ending the loop of an excerpt of a video file after the excerpt has shown one time, or a predetermined number of times, or ending the loop of a slideshow of album art associated with a highlighted audio file, for example. Further simplifications, such as those discussed above, may occur in the right and left display areas in some embodiments, including slowing the display refresh rate, dimming or shutting off the backlight, reducing the number of animation frames or album art images shown, and lowering display resolution, for example. After step 520, the electronic device can resume monitoring the device parameter or parameters at step 512.

Process 500 can further reduce power consumption of the electronic device, which can result in improved efficiency and an enhanced user experience, for reasons similar to those described hereinabove.

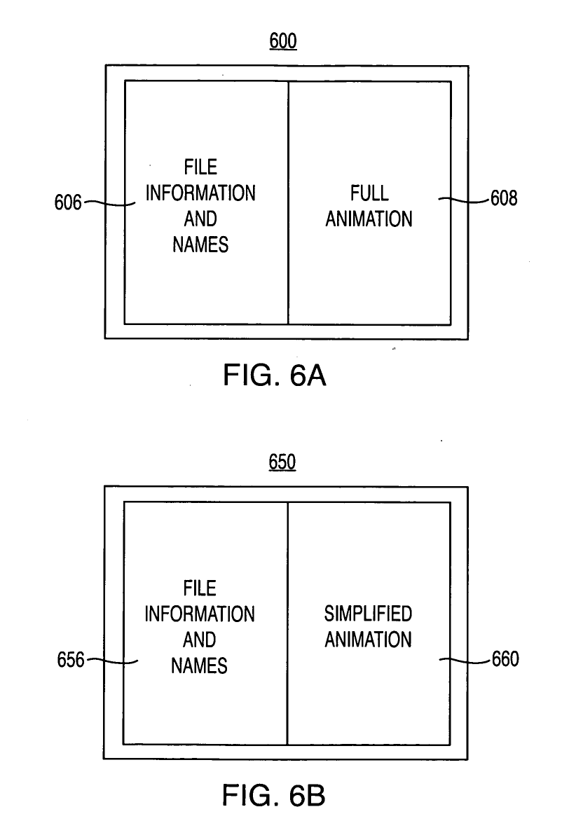

FIGS. 6A-6B show illustrative user interfaces on a display in which a display can be controlled based on one or more monitored device parameters in accordance with another embodiment of the present invention. FIGS. 6A and 6B specifically illustrate embodiments discussed in process 500.

User interface 600 illustrates a preview pane containing left display area 606, which can include file names and information, for example. Right display area 608 can contain full animation related to the highlighted file as described hereinabove in relation to step 518 of process 500. The full animation can be a loop of an excerpt of a video file, the excerpt of which can be contained in a separate file, or can be a preselected section of the video file. The full animation can also be a looping slideshow of album art associated with a highlighted audio file, which can be enhanced with the above mentioned animation techniques, for example.

User interface 650 illustrates a preview pane, containing left display area 656, which can include file names and information, for example, and right display area 660, which can include simplified animation related to the highlighted file, for example, as described hereinabove in relation to step 520 of process 500. The simplified animation can take the form of ending the loop of an excerpt of a video file after the excerpt has shown one time, or a predetermined number of times, or ending the loop of a slideshow of album art associated with a highlighted audio file, for example. Further simplifications, such as those discussed above, may occur in the right and left display areas in some embodiments, including slowing the display refresh rate, dimming or shutting off the backlight, reducing the number of animation frames or album art images shown, and lowering display resolution, for example.

As stated above, the embodiments displayed in user interfaces 600 and 650 can further reduce power consumption of the electronic device, which can result in improved efficiency and an enhanced user experience, for reasons similar to those described hereinabove.

FIGS. 7A-7P show illustrative reduced-color screens that provide device information in accordance with embodiments of the present invention.

Reduced-color screen 7A can provide device information in the form of time stored in the electronic device 702, icon 704, which can show that the device is playing an audio file, and power source status image 706, which can indicate to the user the approximate charge remaining. Reduced-color screen 7A in some embodiments can refresh once a minute, or any desired time period, and can be synchronized to the time stored in the electronic device 702, or to the power source status displayed in 706 (e.g., refresh when the power source depletes to a desired fraction of the full charge).

Reduced-color screen 7B can provide device information in the form of icon 704, power source status image 706, and icon 708, which can be any decorative image desired. Reduced-color screen 7B in some embodiments can refresh once a minute, or any desired time period, and can be synchronized to the time stored in the electronic device, or to the power source status displayed in 706 (e.g., refresh when the power source depletes to a desired fraction of the full charge).

Reduced-color screen 7C can provide device information in the form of the time stored in the electronic device 710 (which can display the time similarly to 702, and can additionally display the “AM” or “PM” designation), and icon 712, which can show that the device is locked. Reduced-color screen 7C in some embodiments can refresh once a minute, or any desired time period, and can be synchronized to the time stored in the electronic device 710, or to the power source status (e.g., refresh when the power source depletes to a desired fraction of the full charge).

Reduced-color screen 7D can provide device information in the form of the time stored in the electronic device 702, and power source status image 714, which can indicate to the user the approximate charge remaining and can use colors to reflect the amount of charge remaining (e.g., red if the amount of charge is below a predetermined fraction of the full charge). Reduced-color screen 7D in some embodiments can refresh once a minute, or any desired time period, and can be synchronized to the time stored in the electronic device 702, or to the power source status displayed in 714 (e.g., refresh when the power source depletes to a desired fraction of the full charge).

Reduced-color screen 7E can provide device information in the form of icon 704 and icon 708. Reduced-color screen 7E in some embodiments can refresh once a minute, or any desired time period, and can be synchronized to the time stored in the electronic device, or to the power source status (e.g., refresh when the power source depletes to a desired fraction of the full charge).

Reduced-color screen 7F can provide device information in the form of the time stored in the electronic device 702, and an icon 716, which can show that the device is playing an audio file. Icon 716 can be similar to icon 704, and can further be a white icon outlined in black, which can improve visibility. Reduced-color screen 7F in some embodiments can refresh once a minute, or any desired time period, and can be synchronized to the time stored in the electronic device 702, or to the power source status (e.g., refresh when the power source depletes to a desired fraction of the full charge).

Reduced-color screen 7G can provide device information in the form of the time stored in the electronic device 718 (which can similar to 702 and be expressed as white text outlined in black, which can improve visibility), and power source status image 706. Reduced-color screen 7G in some embodiments can refresh once a minute, or any desired time period, and can be synchronized to the time stored in the electronic device 718, or to the power source status displayed in 706 (e.g., refresh when the power source depletes to a desired fraction of the full charge).

Reduced-color screen 7H can provide device information in the form of the time stored in the electronic device 702, and power source status image 720, which can indicate to the user the approximate charge remaining similarly to power source status image 706, and can be vertically oriented. Reduced-color screen 7H in some embodiments can refresh once a minute, or any desired time period, and can be synchronized to the time stored in the electronic device 702, or to the power source status displayed in 720 (e.g., refresh when the power source depletes to a desired fraction of the full charge).

Reduced-color screen 7I can provide device information in the form of the time stored in the electronic device 702, icon 704, and power source status image 706. Reduced-color screen 7I in some embodiments can refresh once a minute, or any desired time period, and can be synchronized to the time stored in the electronic device 702, or to the power source status displayed in 706 (e.g., refresh when the power source depletes to a desired fraction of the full charge).

Reduced-color screen 7J can provide device information in the form of icon 704 and power source status image 720. Reduced-color screen 7J in some embodiments can refresh once a minute, or any desired time period, and can be synchronized to the time stored in the electronic device, or to the power source status displayed in 720 (e.g., refresh when the power source depletes to a desired fraction of the full charge).

Reduced-color screen 7K can provide device information in the form of the time stored in the electronic device 722 (which can be similar to 702, can be displayed in white text outlined by a black border, and can include the “AM” or “PM” designation), and icon 708. Reduced-color screen 7K in some embodiments can refresh once a minute, or any desired time period, and can be synchronized to the time stored in the electronic device 722, or to the power source status (e.g., refresh when the power source depletes to a desired fraction of the full charge).

Reduced-color screen 7L can provide device information in the form of the time stored in the electronic device 702, and icon 716. Reduced-color screen 7L in some embodiments can refresh once a minute, or any desired time period, and can be synchronized to the time stored in the electronic device 702, or to the power source status (e.g., refresh when the power source depletes to a desired fraction of the full charge).

Reduced-color screen 7M can provide device information in the form of icon 704, and power source status image 706. Reduced-color screen 7M in some embodiments can refresh once a minute, or any desired time period, and can be synchronized to the time stored in the electronic device, or to the power source status displayed in 706 (e.g., refresh when the power source depletes to a desired fraction of the full charge).

Reduced-color screen 7N can provide device information in the form of icon 704. Reduced-color screen 7N in some embodiments can refresh once a minute, or any desired time period, and can be synchronized to the time stored in the electronic device, or to the power source status (e.g., refresh when the power source depletes to a desired fraction of the full charge).

Reduced-color screen 70 can provide device information in the form of the time stored in the electronic device 702, power source status image 706, and icon 712. Reduced-color screen 70 in some embodiments can refresh once a minute, or any desired time period, and can be synchronized to the time stored in the electronic device 702, or to the power source status displayed in 706 (e.g., refresh when the power source depletes to a desired fraction of the full charge).

Reduced-color screen 7P can provide device information in the form of icon 704, and icon 712. Reduced-color screen 7P in some embodiments can refresh once a minute, or any desired time period, and can be synchronized to the time stored in the electronic device, or to the power source status (e.g., refresh when the power source depletes to a desired fraction of the full charge).

While preferred illustrative embodiments of the invention are described above, it will be apparent to one skilled in the art that various changes and modifications can be made therein without departing from the invention. The appended claims are intended to cover all such changes and modifications that fall within the true spirit and scope of the invention.

What is claimed is:

1. A method for controlling the display of an electronic device, wherein the electronic device is configured to execute applications, wherein the applications are grouped into at least two application classes, comprising:
displaying full graphics in applications belonging to a first application class; and
alternating between displaying full graphics and simplified graphics in applications belonging to a second application class.

2. The method of claim 1, wherein the alternating between displaying full graphics and simplified graphics comprises alternating between displaying graphics in full-color mode and displaying graphics in reduced-color mode in applications belonging to a second application class.

3. A method for controlling the display of an electronic device, the display comprising a full-color mode and a reduced-color mode, comprising:
monitoring at least one device parameter, wherein the at least one device parameter comprises a plurality of states;
displaying graphics in full-color mode when the at least one device parameter is in a first state; and
changing from full-color mode to reduced-color mode when the at least one device parameter is in a second state.

4. The method of claim 3, wherein the monitoring at least one device parameter comprises monitoring user input frequency, wherein changing from full-color mode to reduced-color mode comprises changing from full-color mode to reduced-color mode when the user input frequency compares in a predetermined manner to a predetermined value.

5. A method for controlling the display of an electronic device, comprising:
monitoring at least one device parameter, wherein the at least one device parameter comprises a plurality of states;
displaying full graphics for the electronic device when the at least one device parameter is in a first state; and
changing-from displaying full animations to displaying simplified animations when the at least one device parameter is in a second state.

6. A method for controlling the display of an electronic device, comprising:
monitoring at least one device parameter, wherein the at least one device parameter comprises a plurality of states;
displaying full graphics comprising a full set of status indicators when the at least one device parameter is in a first state; and
displaying simplified graphics comprising a simplified set of status indicators when the at least one device parameter is in a second state.

7. The method of claim 6, wherein the displaying simplified graphics comprises displaying simplified graphics comprising a reduced number of status indicators when the at least one device parameter is in a second state.

8. The method of claim 6, wherein the displaying simplified graphics comprises displaying simplified graphics comprising displaying the status indicators at a lower resolution when the at least one device parameter is in a second state.
